(19) United States
(12) Patent Application Publication
(10) Pub. No.: US 2025/0139066 A1
(43) Pub. Date: May 1, 2025

(54) PHASED CONFIGURATION CHANGES WITH FALLBACK OPTION

(71) Applicant: SAP SE, Walldorf (DE)

(72) Inventors: Peter Eberlein, Malsch (DE); Volker Driesen, Heidelberg (DE)

(21) Appl. No.: 18/498,674

(22) Filed: Oct. 31, 2023

(51) Int. Cl. G06F 16/21; G06F 8/71; G06F 16/215

(52) U.S. Cl. CPC G06F 16/213; G06F 8/71; G06F 16/215

(57) ABSTRACT

In an implementation, providing phased configuration changes with fallback option includes creating, using a context manager (CM), a new context. Using the CM, deploying a new configuration-variant. Using the CM, the new context is assigned for use by users connecting to a database schema of the new context. Using the CM, a determination is made to phase out use of the new configuration-variant. The new context is cleaned up.

### BACKGROUND

In configuration of software applications (for example, Enterprise Resource Planning (ERP)), which have very rich configuration variability, configurations are changed regularly to adjust to new enterprise requirements regarding used software applications. These changes can impact “real-world” processes run by an enterprise using the software applications. A new configuration will traditionally be tested in a dedicated testing setup, which can be costly to setup and keep operational, limited in data scope, and miss issues that can cause negative impacts to a production environment. The question is how to enable a software system to run multiple configuration versions in parallel in the production environment and how to switch and merge transactional data created with these different versions consistently.

### SUMMARY

The present disclosure describes providing phased configuration changes with fallback option.

In an implementation, a computer-implemented method, comprises: creating, using a context manager (CM), a new context; deploying, using the CM, a new configuration-variant; assigning, using the CM, the new context for use by users connecting to a database schema of the new context; determining, using the CM, to phase out use of the new configuration-variant; and cleaning up, using the CM, the new context.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach permits running two configuration-variants in one deployment of a software application with minimal overhead and with capabilities to manage the configuration-variants. Second, users can be assigned to work with a different configuration-variant in a software application than most users, ensuring that software application data (data object instances) are processed with a configuration-variant that they are created with to ensure consistent use during multi-step processes. Third, a configuration-variant can be either revoked—and the created data adjusted to an older configuration-variant—or a new configuration-variant can be made accessible for all users. Fourth, a new configuration within a software application deployment can be explored with a subset of the users and does not need to set up a completely new software application system for the exploration-phase.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is chart illustrating a context usage model and timeline of a process to setup, use, and resolve a configuration-variant, according to an implementation of the present disclosure.

FIG. 1B is flow chart visually illustrating a context usage model and timeline of a process to setup, use, and resolve a configuration-variant as described in FIG. 1A, according to an implementation of the present disclosure.

FIG. 2 is a box diagram illustrating a Context Manager and associated components, persistency, and actions, according to an implementation of the present disclosure.

FIG. 3 is a block diagram illustrating details of a Multi-Version Table, according to an implementation of the present disclosure.

FIG. 4 is a flowchart illustrating an example of a computer-implemented method for setup, use, and resolving a configuration-variant, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes providing phased configuration changes with fallback option and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

In configuration of software applications (for example, Enterprise Resource Planning (ERP)), which have very rich configuration variability, the configurations are changed regularly to adjust to new enterprise requirements regarding used software applications. These changes can impact “real-world” processes run by an enterprise using the software applications. A new configuration will traditionally be tested in a dedicated testing setup. The question is how to enable a software system to run multiple configuration versions in parallel in a production environment and how to switch and to merge transactional data created with these different versions consistently.

In the testing setup, a dedicated test system is typically created and provided with test data, and only a selected set of test-users are involved. The testing setup is typically used for functional correctness tests and not used to test an impact of a change on the enterprise. Since the test setup is a dedicated testing environment and not running on or with full production environment data, users must also be assigned for dedicated test-activities un-related to their day-to-day use of the system and to execute these additional test activities. Moreover, in a dedicated test setup, reconfigured user interfaces (UIs) are evaluated with test-cases. To validate user acceptance, assessment of the changed user experience impact on efficiency and determining which level of user training for the new configuration is required. An environment close to a production environment used with many users is desirable.

A dedicated test setup is costly to setup and keep operational (for example, the software and configuration version must be adjusted to what is running in the production system, required data needs to be copied from the production system and test data needs to be created-either a subset of production data or generated data). Copied production data needs typically to be “anonymized” and “scrambled”, so that no personal, private, or confidential data is replicated, and it should not be possible to read critical insights from the test system. Additionally, test scope is potentially limited in a dedicated test setup, the real impact of process changes on the overall company operations cannot be evaluated.

When a new configuration is tested as described, it is still unclear, if the testing will satisfy enterprise needs, will be accepted by users, or if the testing leads to undesired side-effects. Once a new configuration is deployed to production, the impact is broad, and a rollback includes data loss (“restore backup”) or, more likely, another full-scale configuration change with data migration back to a prior software application version, which is a complex procedure. Both approaches are costly, have substantial enterprise impacts, and prevent quick reactions.

Questions typically asked include:

Are intended key performance indicators (for example, key performance indicators (Key Performance Indicators (KPIs)) and business goals) with a configuration change (for example, user experience, process efficiency, and financial impact)? Evaluating beyond technical testing of correctness and beyond evaluating results of a (small) group of testers is needed. What is the impact of a configuration change on KPIs measured for both old and new business configurations in parallel?

How can one test iterations of configuration-variants quickly and with low overhead? Configuration-variants are typically not changing a large set of data records, but small changes still have broad impact on the behavior of a software application. It is desirable to have an option to quickly create a new configuration-variant, test it with users, and optimize. Once the iteration results in a desired configuration-variant, it should be activated quickly for all users. The speed of iteration is therefore critical, and this implies that setup, adjustment, and tests need to be fast-running and with non-intensive resource operations without a long preparation setup. Note that the described approach is not A/B (split) testing and is not addressing a low-level, technical configuration where a switch can be flipped back and forth as in A/B testing. The described approach changes a process configuration that affects how the processes are executed (for example, testing effects of adding an additional logistics provider for shipments). In this example, Shipper B is added and offered as a choice for shipping items. Now after a few weeks, the addition is not seen as desired, and it is decided to remove Shipper B as an option. All items that were ordered with the Shipper B option and have been shipped are good, but those still “in transit” need to finish their process (that is, the items need to still be shipped by Shipper B and tracking data needs to be supplied to a customer). If Shipper B is simply removed the Shipper B option from a process configuration, the system would no longer offer tracking links to Shipper B as this is no longer a valid option. All processes started with the Shipper B option need to be completed before being disabled, however new shipping using Shipper B should not be allowed, but the option is needed for prior processes. This can be complicated, as new follow-up data objects might need to be created after the Shipper B option is disabled (for example, if an order was created with Shipper B, but by time the option Shipper B is disabled a delivery note has not been created). Process logic still needs to be able to create a delivery note with Shipper B, which would be unavailable with conventional approaches.

Is limited phased testing for configurations in a production environment feasible? Configurations are stored in many views/tables and consumed by many software applications and database views. If a new variant is to be deployed to a production environment, next to an existing productively used variant, it needs to be ensured that running processes are not impacted-only intended users and software application domains see the changes, and very importantly, that the change can be revoked easily without restoring from a database backup. Adjusting a configuration is typically not a “local change”.

Within a long running (enterprise) process execution, how can all process steps be consistently executed (potentially performed by different users/user groups) with one and the same configuration-variant and not switching back-and-forth between general use and test configurations as they are activated/deactivated during process execution? As an example, user group A and B may use different configuration-variants to restrict a scope of testing, therefore starting processes with different configurations and creating objects with these respective different configurations. Once a process is initiated, it should be completed with the configuration it started with. If other users are involved later in the process, the other users need to continue the process within the same configuration-variant.

How to handle two configuration-variant versions in a persistency? Two configuration-variants need to be able to be stored in parallel. As a complete configuration set might be large and a change small-how can deployment of the change be optimized to only deploy a delta (this would be faster and consume less memory)? While working with two sets of configurations, it is not optimum to store two sets of transactional data. However, one needs to annotate that certain transaction data has been created (or is being processed) by another test configuration-variant.

At a high-level, the described approach:

Enables storing of two configuration-variants in a database of a software application in parallel, which enables controlled and consistent use of the configuration-variants when creating, modifying, or reading application object instances.

Enabling processes to create application object instances with one configuration-variant and completing the processes with the started configuration-variant, which might comprise switching configuration-variants for a user when reading a software application object instance created in another configuration-variant and creating succeeding application objects with the same configuration-variant as a preceding object.

Finalizing a test of a configuration-variant by preventing creation of new software application object instances with a tested configuration-variant, while allowing existing application object instances to still finish their processes with the configuration-variant before finally deactivating the tested configuration-variant and switching to the general one.

For the purposes of this disclosure, terminology includes a Configuration-Variant (CV), Application-Object-Instance (AOI), and Context Manager (CM). A “context” is defined to be an organizational artifact (for example, a database container) used to organize different aspects of managing and using a configuration-variant. The context contains the configuration-variant (stored in a database schema associated with the context). A context has: 1) an ID (for example, characters ‘A’, ‘B’, . . . ); 2) a lifecycle-/context-state (for example, “prepare”, “deploy”, “restricted use”, “general use”, “phase-out”, “merge”, “clean-up”) informing about the phase of the context; 3) a database schema for configuration access (for example, named with reference to the context ID-‘SCHEMA_A’, . . . ); and 4) an attribute in a user session: a) specifying the context to use and b) determining the corresponding database schema to connect to. The context-ID is used: 1) to separate data of different configuration-variants in the DB (is a “key field for configuration tables”) and 2) to annotate transactional data, that the data was created with a certain configuration-variant and therefore will continue to be processed with this configuration-variant (is a “data field for application/transaction data tables”).

### Process

In some implementations the describe approach includes pre-conditions: 1) the system is prepared to run “Multi Version Table Support” for configuration tables; 2) there is a default context in use, called “general use” (for example, having ID ‘A’ (104a)); and 3) there is potentially one or more test context(s) in “restricted use” (for example, by selected users, such as, ‘B’ (106a)).

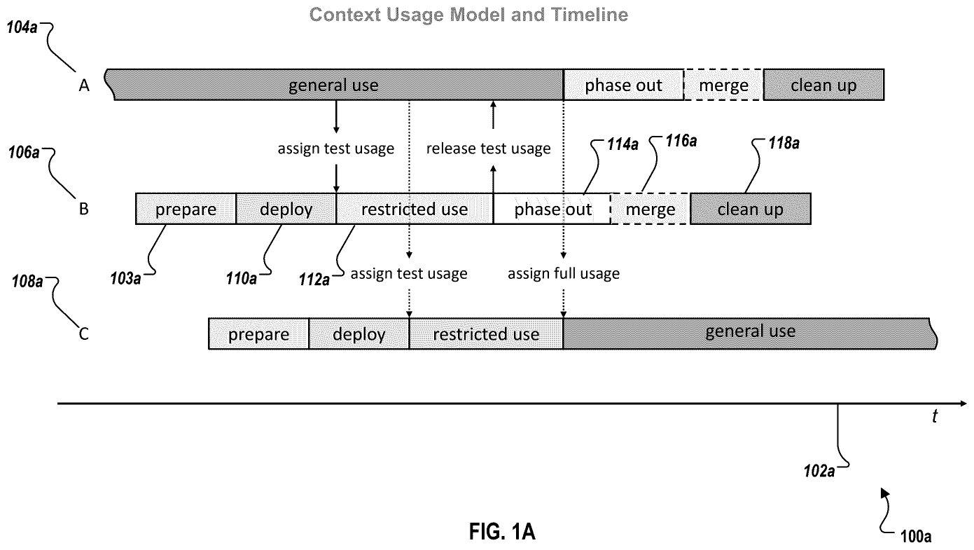

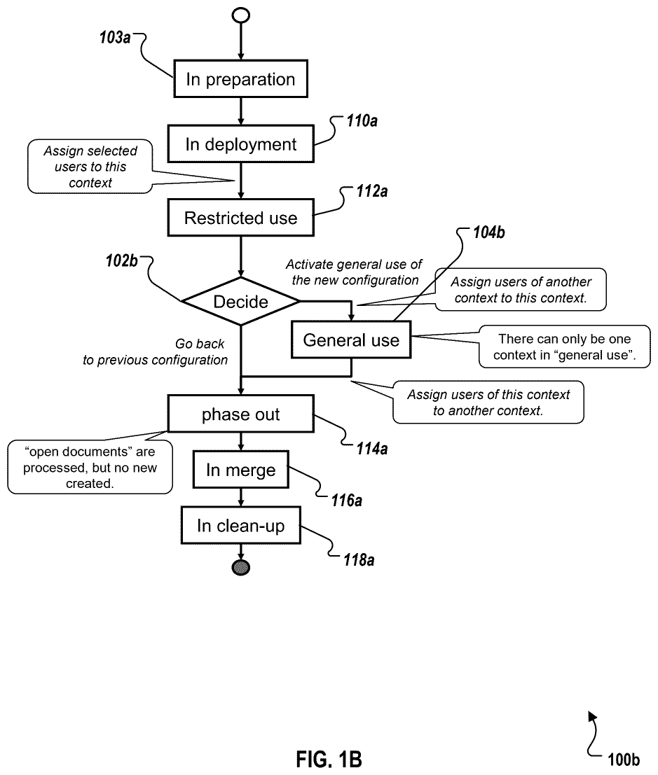

FIG. 1A is chart 100a illustrating a context usage model and timeline of a process to setup, use, and resolve a configuration-variant, according to an implementation of the present disclosure.

Time is indicated by timeline 102a, which increases toward the right.

### Prepare (103a)

In some implementations, preparation includes both technical preparation and content preparation.

### Technical Preparation

A Context Manager (CM) creates a new context. First, CM sets up an environment in a database to enable managing another context: 1) this can be a change to support two contexts, currently having only one (the previously mentioned general use default context ‘A’ (104a)) and resulting in two contexts (for example, ‘A’ (104a) and ‘B’ (106a)) or 2) this can be a change to support <n> contexts (n>2), currently having <n−1> contexts, to test <n−1> contexts in parallel to the general use context and resulting in contexts (for example, ‘A’ (104a), ‘B’ (106a), and ‘C’ (108a), . . . ). In the following explanation, ‘C’ is used to talk about a setup of a new context, and ‘<blank>’ is used to specify ‘ ’ more explicitly, which is a context independent identifier).

A Context Lifecycle Manager module of the CM: 1) sets a context state to ‘prepare’ (stored in persistency “Context_Status”); 2) creates another database schema for context ‘C’ (108a): ‘SCHEMA_C’; 3) creates database views in the database schema ‘SCHEMA_C’ (refer to “Multi Version Table Support”); and 4) configures a database interface to connect to schema ‘SCHEMA_C’ for user sessions using context ‘C’ (108a).

### Content Preparation

An administrator (for example, a system administrator) specifies, that a new configuration-variant is to be tested. To accomplish this, the administrator configures a new context ‘C’ (108a) in the CM. The administrator selects a configuration-variant to deploy to this context in the CM. Here: 1) a configuration-variant can be a set of parameters changed in configuration tables; 2) it is not required to deploy a full configuration set; it is sufficient to only deploy the changed configuration parameters; 3) from the selected configuration-variant, impacted software domains (for example, “Order-Fulfillment”) are derived (where, objects created in this domain depend on the configuration-variant and, in contrast, not impacted software domains are those that do not evaluate any configuration option that is changed with the configuration-variant); and 4) the administrator can de-select software domains from the proposal, if they will not be tested (for example, configuration impacts not only procurement but also financials, but this domain will not be altered since a month closing activity is approaching and it will not be impacted)—which makes it possible to limit scope of testing configuration changes.

### Deploy (110a)

Option 1: Deployment from a Central Configuration

With this option, the same configuration setting might be replicated to multiple system, where it could be handled consistently, supporting cross-system fallback. Once a setup of context ‘C’ is completed, the new configuration-variant can be deployed.

The Context Manager: 1) sets the context to state ‘deployment’; 2) configures a deploy tool to use the new context ‘C’ (108a) (that is, connect to schema ‘SCHMEA_C’); 3) the data written by the deploy tool to the context ‘C’ (108a) is only visible for users of the context ‘C’ (108a) and is not visible when users are working in another context ‘A’ (104a) or ‘B’ (106a); and 4) once the deployment is completed, CM sets the context ‘C’ (108a) to ‘restricted-use’.

### Option 2: In-Place Configuration Change

Instead of deploying a configuration-variant, which is created in a central configuration management system or a related development system, the configuration-variant could also be created in the system directly. In this implementation, instead of previously described deployment step, the administrator would assign a number of configuration-developers to the new context and specify the configuration management component in the system to the set of software domains “impacted” by the configuration-variant. When configuration-developers call a configuration management UI, they are assigned to the new context ‘C’ (108a). When configuration data is created or changed, the data is written for the context (and not visible in other contexts, as in the case where the data is deployed).

### Restricted Use (112a)

The administrator specifies usage criteria of the new context ‘C’ (108a) in the CM:

1) IDs of the users who shall use the new context to create new objects when starting new processes. This option is preferred if users require at least minimal education or training to be able to work with the tested configuration-variant. Note that “users” here can also be technical users, so it is possible to run cross-system processes with a specific configuration-variant by assigning it to the technical user that is configured for a specific integration process.

2) A percentage of objects being created using the new context. This option is preferred for assessing a broad impact of the configuration-variant on a full user-base. In this option, the administrator can further select if the random assignment of the specified context should apply only to end-users, technical users, or both. Users would randomly be assigned to the new context to create objects using the new configuration-variant available in the context.

The new context ‘C’ (108a) can now be used by the selected users/for random assignment. When the context is in ‘restricted-use’ and users are assigned to the context (explicitly by user-ID or randomly, based on a defined probability), their next activity in a software domain configured for the new context will initiate a user session, which will connect to the database with the new context, read the respective configuration-variant, and write data with annotated context-ID.

During restricted use, characteristics of the system has various characteristics:

If no context is specified, the system uses the “general use” context (default), otherwise the assigned context is used.

The respective context-ID and schema name can be read from the Context Manager persistency. For example, context ‘A’ (104a) is in status “general use”, the schema to connect to is ‘SCHEMA_A’.

If an application object to be created belongs to a domain, and for the domain one or more contexts other than the “general use” context are configured, then the object is created within such a “restricted use” context if, either:

1) The preceding object was created in one of these contexts. The preceding object then “inherits” its context to the succeeding object, replacing any previously assigned context, potentially forcing a user from outside the assigned user group into the context to ensure configuration-variant consistency within the running process. Here, a “preceding object” is an object created in the same business process, during an earlier step of the process. For example, a “Sales-Order” is a “preceding object” of an “Invoice” or a “Shipping-Document” in an order process.

OR

2) The currently assigned context (from user or random) is one of these contexts, then this context is used. In this way, the use of the context can be limited only for configurations of certain software domains.

If a certain user action will be executed in a certain “restricted use” context, the context ID is specified in the respective user session in the application server using a “Context Assigner”.

Upon connection to the database, the database interface reads the context ID from the user session and switches the database connect of this session to the database schema related to the context. For example, the session is configured with context ID ‘B’ (106a) and the database interface thus connects to ‘SCHEMA B’.

Optionally, a user interface (UI) can be extended to display information when data is processed within a non-general-use context. For configuration-evaluations, which are not “blind tests”, users can be informed when an object or process is executed within a “restricted use” or “phase-out” context. In this way, a user can be alerted about an exceptional context being used for the process and additional helpful information can be provided.

### Context Assigner

The Context Assigner sets the context-ID of a user session upon start of a new transaction:
If the action to be performed is to create a new object instance
   *and* if the user is assigned to a restricted use context or a random assignment of a restricted use context shall be done for this transaction based on the configured probability,
   *and* if for the software domain in which the object shall be created, this restricted use context is configured,
   *then* this restricted use context is used.
*or* if the existing object instance being processed has been created within a restricted use context,
   *then* this restricted use context is used, and the user is dynamically switched to this restricted use context, even if the user was not explicitly assigned to this restricted use context originally.
*or* if the object instance being created newly is a successor object of an object that had been created in a restricted use context.
   *and* the new object instance is within a software domain for which this restricted use context is configured as well.
   *then* this restricted use context is used, and the user is dynamically switched to this restricted use context, even if the user was not explicitly assigned to this restricted use context originally.
*else* if the new object instance is within a software domain for which this restricted use context is not configured,
   *then* the same logic as described above for creating a new object instance is applied.

The Context Assigner sets the “general use” context if the previously described conditions do not result to true. This acts as a fallback if the context ID in the user session is not set explicitly, the default is mapped to “general use”, and the respective context and schema are used.

The following description is phrased in a different matter and provides a visual representation of the described approach.

With focus on single objects (new or existing) (refer to Table 1).

If an object is newly created: If the object is within a software domain, which is configured for a context, *and* the user is assigned to the restricted use context or the restricted context was randomly chosen based on the configured probability, *then* the object is created within this context.

If an existing object is read/modified, any user working with an existing object is switched to the context, the object was created in. Thus, using the same context is used even when the process continues with another user. The persistency of the object instances is amended with the context information to enable.

TABLE 1

| | | Object | | | | | |
|---|---|---|---|---|---|---|---|
| | | New object | | | Existing object | | |
| | | In software domain | | | Read context from | | |
| | | context | | | object | | |
| User context | | A *) | B | C | A *) | B | C |
| General | A *) | Use A | Use A | Use A | Use A | Use B | Use C |
| use | | | | | | | |
| Restricted | B | Use A | Use B | Use A | Use A | Use B | Use C |
| use | | | | | | | |
| Restricted | C | Use A | Use A | Use C | Use A | Use B | Use C |
| use | | | | | | | |

*) A = default general use context.

Objects managed in processes, with predecessor/successor objects (refer to Table 2).

The idea here is, that a process remains in the context, if possible, but still enabling that successor objects can be created in a (different) restricted use context, if the predecessor was in a general use or another restricted use context that is not configured for the software domain of the successor object.

If a process is started within a software domain configured for a certain context:
If a user who is assigned to this context starts the process—or by random assignment to use this context, the process is attributed with the information, that this context is used (for example, ‘C’ (108a)).
The first object being created is thus created within the context, that the user is assigned to (see table above, “New object”).
If a user executes a subsequent step within the process, three attributes have to be evaluated:
   The context, the predecessor object was created in.
   The context, the user is assigned to/the random context determined based on probability configuration.
   The contexts(s), the software domain is configured for, comprising the new object. →Objects can only be created in a context if the software domain is configured for the context.
If the successor object is part of a software domain configured for the context:
   The context is used (inherited) if the predecessor object had been created in this context.
To enable this, the persistency to store process instances and status are amended with the context information.

TABLE 2

| | | Object | | | | | | | | |
|---|---|---|---|---|---|---|---|---|---|---|
| | | New successor object | | | New successor object | | | New successor object | | |
| | | Is in software domain, | | | Is in software domain, | | | Is in software domain, | | |
| | | that is not configured -> | | | configured for | | | configured for | | |
| | | fallback A *) | | | context B | | | context C | | |
| Predecessor | | A *) | B | C | A *) | B | C | A *) | B | C |
| object context | | | | | | | | | | |
| User context | | | | | | | | | | |
| General | A *) | Use A | Use A | Use A | Use A | Use B | Use A | Use A | Use A | Use C |
| use | | | | | | | | | | |
| Restricted | B | Use A | Use A | Use A | Use B | Use B | Use B | Use A | Use A | Use C |
| use | | | | | | | | | | |
| Restricted | C | Use A | Use A | Use A | Use A | Use B | Use A | Use C | Use C | Use C |
| use | | | | | | | | | | |

*) A = default general use context.

### Phase-Out (114a)

Once a configuration-variant is in “restricted use” for a certain period, the admin can evaluate, if it shall be used further on as “general use” and the former “general use” context is switched to phase-out, or if the context in “restricted use” is not considered valuable and switched to “phase out”.

The administrator can evaluate KPIs related to the processes and objects being impacted by the configuration-variant (that is, the objects and processes of the configured domains, in the diagrams (for example, domains D2 and D3 for context ‘B’ (106a)) and assess user feedback and come to a decision how to proceed with the configuration-variant evaluated in this context.

The administrator enters the decision in the CM Maintenance UI.

The administrator can decide how to move forward with a configuration-variant (available in a context):
a) Do not activate the new configuration-variant (for example, ‘B’ (106a) in FIG.
   1A) and continue with the old configuration.
      Set the context ‘B’ to “phase out”.
      Remove user assignments from context ‘B’ (106a) (in User_Context_Assignment).
      Remove the records with object probabilities for context ‘B’ (106a) from Probability_Context_Assignment.
      This implicitly assigs the users to use the default configuration again-available in context “general use”, in our example ‘A’ (104a).
      Further on, new objects are created with the context of this configuration-variant again (‘A’ (104a)).
      Existing objects created in context ‘B’ (106a) remain unaffected by this change (that is, they are still processed with their configuration-variant until they are completed).
b) Keep the new configuration-variant (for example, ‘C’ (108a) in FIG. 1A) and activate for “general use”.
   Set the context ‘C’ (108a) to “general use”, and set the former context, which had been in “general use” to “phase out”.
   This implicitly assigs all users to use the (new) default configuration available in the “general use” context, in our example now ‘C’ (108a).
   Remove the user assignments from context ‘C’ (108a) (in User_Context_Assignment) used during the “restricted use” period, this configuration is no longer needed, as users are per default using the “general use” context, which is now ‘C’ (108a).
   Remove the records with object probabilities for context ‘C’ (108a) from Probability_Context_Assignment.
   Further on, new objects are created with this new configuration-variant (‘C’ (108a)) only.

Existing objects are processed within the context they have been created in until they are “completed”/“closed” (if the objects have a lifecycle state). For example, “open documents” (“offene Belege”) are completed within the context they have been created in to ensure that the objects are processed with a consistent configuration-variant through their lifecycle.

When no “open object” is found any more (no object lifecycle other than “complete”/“closed”) in a context which is in state “phase out”, the CM sets the context to “merge”. Further on, no object is processed with this context any longer.

The CM removes the configuration entries for the domains assigned to the context from the persistency “Domain_Context_Map”.

### Merge (Optional Step) (116a)

The CM can run a program to migrate data of objects which had been created within the context ‘in merge’ to the default context. For example, attributes of application object instances being created in the “restricted use” configuration could be mapped to value sets of the current default configuration, available using the “general use” context.

The context is then set to status “clean-up”.

### Clean-Up (118a)

The context can now be deleted (that is, this is a “garbage collection process”).

The Context Manager deletes the context (for example, ‘A’ (104a)) in application/transaction data tables:
If there are currently two contexts ‘A’ (104a) and ‘B’ (106a), and after deletion it is only one, ‘B’ (106a):
   The value of the context which is to be deleted (for example, ‘A’ (104a)) is set to ‘<blank>’.
   The value of the other context (the only one remaining) (for example, ‘B’ (106a)) is set to ‘<blank>’
If there are several contexts ‘A’ (104a), ‘B’ (106a) and ‘C’ (108a) (and only one is removed, ‘A’ (104a)):
   The value of the context which is to be deleted (for example, ‘A’ (104a)) in the application/transaction data tables is set to ‘<blank>’.
   Other context information is kept (for example, ‘B’ (106a), ‘C’ (108a)).

The configuration-variant of the context (for example, ‘A’ (104a)) can now be deleted from the configuration tables in the DB:
Records in the configuration table with the context value are deleted (for example, delete records with context ‘A’ (104a)).
If only one context remains (for example, ‘B’ (106a)), the values of the other context are set to ‘<blank>’ (for example, update ‘B’ (106a) to ‘<blank>’).
If there are two contexts remaining (for example, ‘B’ (106a) and ‘C’ (108a)), these values are kept in the configuration tables.

The Context Manager removes the context from the configuration table(s).

Optionally, the DB schema ‘SCHEMA_A’ of context ‘A’ (104a) can be deleted. Note that ‘SCHEMA_A’ of context ‘A’ (104a) can also be kept for the next deployment to make setup faster. In this case, the context could be set to ‘un-used’

FIG. 1B is flow chart 100b visually illustrating a context usage model and timeline of a process to setup, use, and resolve a configuration-variant as described in FIG. 1A, according to an implementation of the present disclosure.

Building on the discussion of FIG. 1A and referring to the Context Assigner discussion above, at 102b, a decision is made by the Context Assigner as to which context-ID of a user session should be set upon start of a new transaction. At 104b, and as previously described, the Context Assigner sets the “general use” context if the described conditions do not result to true. This acts as a fallback if the context ID in the user session is not set explicitly, the default is mapped to “general use”, and the respective context and schema are used.

### Components

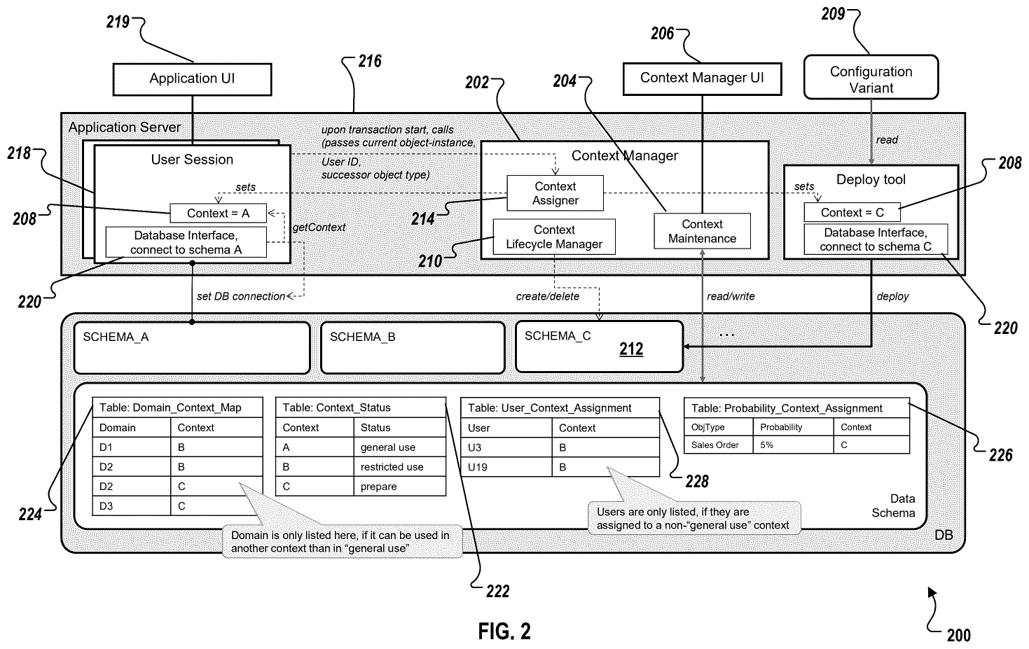

FIG. 2 is a box diagram 200 illustrating a Context Manager and associated components, persistency, and actions, according to an implementation of the present disclosure.

The CM 202 includes a Context Maintenance (204) component, including a Context Manager UI (206). An administrator can use the Context Manager UI (206) to configure a new context, for example, context ‘C’ (208) and to specify a configuration-variant (209) to be deployed.

The configuration-variant (209) is analyzed, and impacted software domains are derived (for example, for a new variant, assigned to context ‘C’ (208), domains D2, D3, and D5). The administrator can select software domains not to be considered in the context (for example, domain D5). The administrator can also specify a percentage of new objects to create within the context (for example, 5% of “Sales Orders” to be created in context ‘C’ (208)). User IDs of users to use the new context for all new objects in configured domains can also be specified.

A Context Lifecycle Manager (CLM) (210) is used to create a database schema (for example, SCHEMA_C (212)). CLM (210) is also used to create views in the database schema (refer to “Multi Version Table Support”). CLM (210) configures “before triggers” (refer to “Multi Version Table Support”). CLM (210) also configures, which context to use which database schema (for example, context ‘C’ (208) to use schema ‘SCHEMA_C’ (212)). CLM (210) also deletes views/triggers and database schemas.

Context Assigner (CA) (214) component is called upon “transaction start” by an Application Server (216) for a User Session (218) (for example, using Application UI (219)). The CA (214) is passed a user-ID, a read object-instance (if there is one and not on a “create new instance” activity) and optionally a successor object type). The CA (214) computes a context to use (previously described in Context Assigner). The CA (214) specifies a context ID to be used in a User Session 218. The context ID in the User Session 218 is used by a Database Interface (220) to connect to a respective database schema as configured by the CLM (210).

The CM (202) has a runtime persistency. A Context_Status is used to store a context status (for example, “prepare”, “deploy”, “restricted use”, “general use”, “phase out”, “merge”, “clean up”). Table: Context_Status (222) illustrates example contexts and Context_Status.

The CM (202) also has a configuration persistency. For example, logic could state that only users and domains are listed, for which a context in status “restricted use” or “phase out” will be used, and users and domains not listed are considered to use a “general use” context. A Domain_Context_Map (for example, Table: Domain_Context_Map (224)) is used to store which contexts are to be considered within a software domain. A Probability_Context_Assignment (for example, Table: Probability_Contect_Assignment (226) is used to store a configuration for objects of a certain type that are created with a certain probability within a specified context. A User_Context_Assignment (for example, Table: User_Context_Assignment (228) is used to store a configuration of which users are assigned to which contexts.

### Multi-Version Table Support

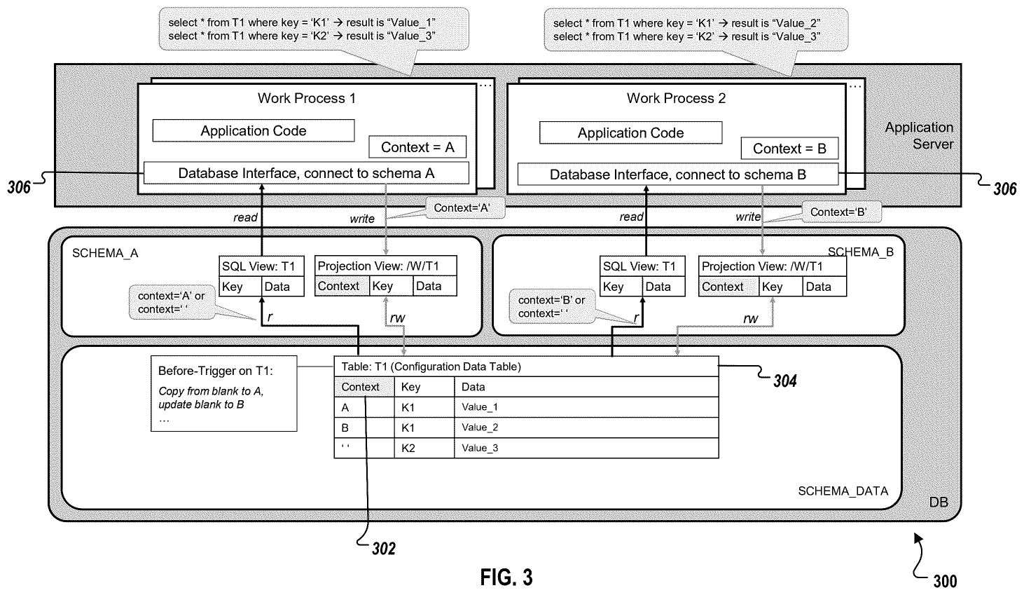

FIG. 3 is a block diagram 300 illustrating details of a Multi-Version Table, according to an implementation of the present disclosure.

To store small deltas of configuration data efficiently and to minimizing deploy time for a new configuration-variant, the concept of a “Multi Version Table” is used. A key column “context” (302) is added to configuration tables (for example, Table: T1 (Configuration Data Table) (304)). The column “context” (302) can have a default value (for example, ‘blank’ or context specific values, e.g. ‘A’, ‘B’, and ‘C’).

A context reads records with ‘blank’ and the context ID. Update-logic ensures that only one value will be returned (for example, that there are not records with both ‘blank’ and ‘A’).

The column “context” (302) is not exposed to read-consumers. In this way, the read-consumers do not need to be aware that a Multi-Version Table is being used.

When writing to the Multi-Version Table, a Database Interface (306) is configured to write to a projection view of the table exposing the context field.

The Database Interface (306) is then configured depending on the situation. If only one context exists, the Database Interface (306) writes with a context value being set to blank. If two or more contexts exist, the Database Interface (306) writes with a context value being set to the context ID of the context. If a record is written with a context value set differently than ‘blank’, before-trigger logic on the table will create a set of identical records for each available context, delete the ‘blank’ record, and then execute a context local update. In this way, other contexts do not see a change done to records within one context. Each context can modify records individually, without impacting other contexts. The un-changed records are not duplicated in the database.

If a new context ‘C’ is created in the database:
A new DB schema is created ‘SCHEMA_C’.
Within the schema, views are created to access the configuration table.
For each configuration table T1, two views are created:
   CREATE view SCHEMA_C.T1 as select <field-list, w/o CONTEXT> from DATA.T1 WHERE CONTEXT=“C” or CONTEXT=“ ”.
   CREATE projection view SCHEMA_C.“/W/T1” as select <field-list> from DATA.T1.
A database before trigger is created, “cloning” blank records before change within one context: it mainly does this:
   insert into DATA.T1 CONTEXT=“C”, <key>=<key-values> as select <field-list> from DATA.T1 where CONTEXT=“ ” and <key>=<key-values>.
   insert into DATA.T1 CONTEXT=“B”, <key>=<key-values> as select <field-list> from DATA.T1 where CONTEXT=“ ” and <key>=<key-values>.
   update DATA.T1 set CONTEXT=“A” where CONTEXT=“ ” and <key>=<key-values>.
When the context ‘C’ is created, it needs to be specified which of the existing schemas is the “parent” schema. The changes in the new schema ‘SCHEMA_C’ are then a delta compared to the parent.
   For example, if ‘C’ is created and ‘B’ is the parent, during setup some records need to be cloned:
   CONTEXT=‘ ’->no action required.
   CONTEXT=‘A’->no action required.
   CONTEXT=‘B’->copy the record with CONTEXT=‘B’ to CONTEXT=‘C’.

### Difference Between a Two-Version Table and a Symmetric Multi-Version Table

A Two-Version Table” (2VT) was designed for use in an upgrade scenario: a system is running with applications using the database, and in parallel an upgrade is modifying the database content. The paradigms in this scenarios are: 1) it is OK for the upgrade to see new application content, this is thus allowed (technically, this means that write statements by applications do not result in a “clone-on-write”); 2) it is not OK for the application to see new upgrade content, this is thus prevented (technically, this means, the write statements by an upgrade first executes a “clone-on-write” and then modifies the cloned record); 3) there is no need for a third process with a different context (due to complexity, a patch is not needed during an upgrade; only two versions are managed). Therefore, the Two-Version Table design is asymmetric, changes done by an application and upgrade differ, as well as what the application and upgrade see in terms of data modified by respective other processes.

The Symmetric Multi-Version Table (SMVT) design aims to provide not only two, but an arbitrary number of contexts. Secondly, the SMVT provides the same behavior in terms of what is happening during read and write to all consumers in all contexts. This way, with the SMVT additional use cases can be realized (for example, that two users of an application use two contexts and have the same behavior, no one is limited or preferred over the other. In case of conflicting modifies by the different users in the different contexts, a merge and consolidation is executed).

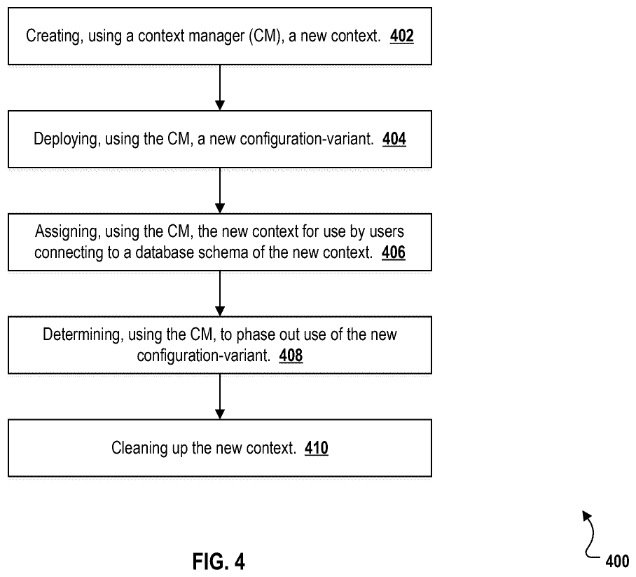

FIG. 4 is a flowchart illustrating an example of a computer-implemented method 400 for setup, use, and resolving a configuration-variant, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, using a context manager (CM), creating a new context. In some implementations, creating, using a CM, a new context, includes: setting a context state to prepare; creating a database schema for the new context; creating a database view in the database schema; and configuring a database interface to connect to the database schema for user sessions of users using the new context. From 402, method 400 proceeds to 404.

At 404, using the CM, deploying a new configuration-variant. In some implementations, deploying, using the CM a new configuration-variant, includes: setting a context state of the new context to deployment; configuring a deploy tool to use the new context; and upon completion of the deploying, configuring the context state of the new context to restricted use. From 404, method 400 proceeds to 406.

At 406, using the CM, assigning the new context for use by users connecting to a database schema of the new context. In some implementations, assigning, using the CM, a context for use by users connecting to a database schema for the new context, includes: specifying usage criteria of the new context, wherein the usage criteria includes: IDs of users that will use the new context to create new data objects when starting new processes; and a percentage of new data objects to be created using the new context. From 406, method 400 proceeds to 408.

At 408, determining, using the CM, determine to phase out use of the new configuration-variant. In some implementations, determining, using the CM, to phase out use of the new configuration-variant, includes: switching, using the CM, a context state of the new context to phase-out, including: processing existing data objects within the new context until they are considered closed; and upon a determination that the existing data objects are closed and the context state of the new context is phase-out: setting the context state of the new context to merge; and removing configuration entries for domains assigned to the new context. In some implementations, data of data objects created while the new context is in the context state of merge are migrated to a default context. From 408, method 400 proceeds to 410.

At 410, using the CM, cleaning up the new context. In some implementations, cleaning up the new context, includes: setting a context state of the new context to clean-up; deleting the new configuration-variant; removing the new context from configuration tables; and deleting the database schema of the new context. After 410, method 400 can stop.

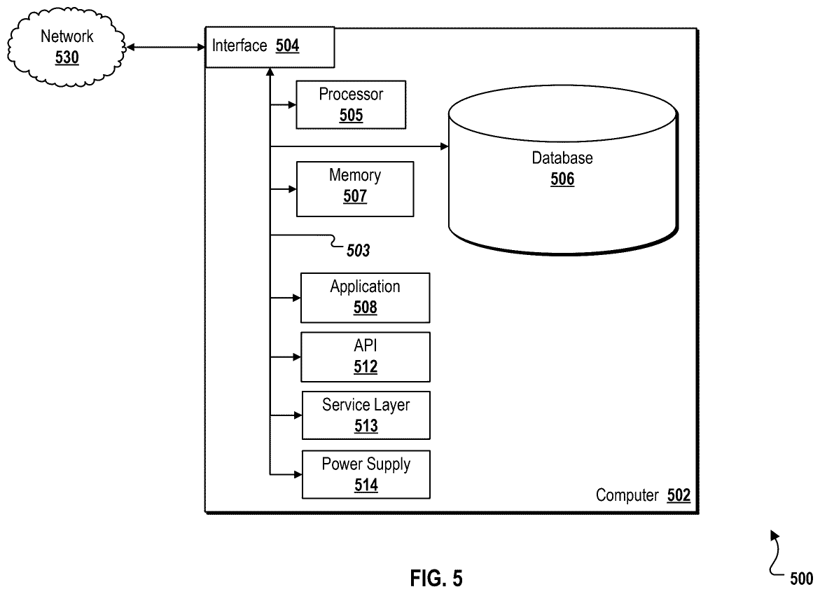

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, System 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprising: creating, using a context manager (CM), a new context; deploying, using the CM, a new configuration-variant; assigning, using the CM, the new context for use by users connecting to a database schema of the new context; determining, using the CM, to phase out use of the new configuration-variant; and cleaning up, using the CM, the new context.

The foregoing and other described implementations can each, optionally, include one or more of the following features:

A first feature, combinable with any of the following features, wherein, creating, using a CM, a new context, comprises: setting a context state to prepare; creating a database schema for the new context; creating a database view in the database schema; and configuring a database interface to connect to the database schema for user sessions of users using the new context.

A second feature, combinable with any of the previous or following features, wherein deploying, using the CM a new configuration-variant, comprises: setting a context state of the new context to deployment; configuring a deploy tool to use the new context; and upon completion of the deploying, configuring the context state of the new context to restricted use.

A third feature, combinable with any of the previous or following features, wherein assigning, using the CM, a context for use by users connecting to a database schema for the new context, comprises: specifying usage criteria of the new context, wherein the usage criteria comprises: IDs of users that will use the new context to create new data objects when starting new processes; and a percentage of new data objects to be created using the new context.

A fourth feature, combinable with any of the previous or following features, wherein determining, using the CM, to phase out use of the new configuration-variant, comprises: switching, using the CM, a context state of the new context to phase-out, comprising: processing existing data objects within the new context until they are considered closed; and upon a determination that the existing data objects are closed and the context state of the new context is phase-out: setting the context state of the new context to merge; and removing configuration entries for domains assigned to the new context.

A fifth feature, combinable with any of the previous or following features, comprising: migrating, to a default context, data of data objects created while the new context is in the context state of merge.

A sixth feature, combinable with any of the previous or following features, wherein cleaning up the new context, comprises: setting a context state of the new context to clean-up; deleting the new configuration-variant; removing the new context from configuration tables; and deleting the database schema of the new context.

In a second implementation, a non-transitory, computer-readable medium storing one or more instructions executable by a computer system to perform one or more operations, comprising: creating, using a context manager (CM), a new context; deploying, using the CM, a new configuration-variant; assigning, using the CM, the new context for use by users connecting to a database schema of the new context; determining, using the CM, to phase out use of the new configuration-variant; and cleaning up, using the CM, the new context.

The foregoing and other described implementations can each, optionally, include one or more of the following features:

A first feature, combinable with any of the following features, wherein, creating, using a CM, a new context, comprises: setting a context state to prepare; creating a database schema for the new context; creating a database view in the database schema; and configuring a database interface to connect to the database schema for user sessions of users using the new context.

A second feature, combinable with any of the previous or following features, wherein deploying, using the CM a new configuration-variant, comprises: setting a context state of the new context to deployment; configuring a deploy tool to use the new context; and upon completion of the deploying, configuring the context state of the new context to restricted use.

A third feature, combinable with any of the previous or following features, wherein assigning, using the CM, a context for use by users connecting to a database schema for the new context, comprises: specifying usage criteria of the new context, wherein the usage criteria comprises: IDs of users that will use the new context to create new data objects when starting new processes; and a percentage of new data objects to be created using the new context.

A fourth feature, combinable with any of the previous or following features, wherein determining, using the CM, to phase out use of the new configuration-variant, comprises: switching, using the CM, a context state of the new context to phase-out, comprising: processing existing data objects within the new context until they are considered closed; and upon a determination that the existing data objects are closed and the context state of the new context is phase-out: setting the context state of the new context to merge; and removing configuration entries for domains assigned to the new context.

A fifth feature, combinable with any of the previous or following features, comprising: migrating, to a default context, data of data objects created while the new context is in the context state of merge.

A sixth feature, combinable with any of the previous or following features, wherein cleaning up the new context, comprises: setting a context state of the new context to clean-up; deleting the new configuration-variant; removing the new context from configuration tables; and deleting the database schema of the new context.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: creating, using a context manager (CM), a new context; deploying, using the CM, a new configuration-variant; assigning, using the CM, the new context for use by users connecting to a database schema of the new context; determining, using the CM, to phase out use of the new configuration-variant; and cleaning up, using the CM, the new context.

The foregoing and other described implementations can each, optionally, include one or more of the following features:

A first feature, combinable with any of the following features, wherein, creating, using a CM, a new context, comprises: setting a context state to prepare; creating a database schema for the new context; creating a database view in the database schema; and configuring a database interface to connect to the database schema for user sessions of users using the new context.

A second feature, combinable with any of the previous or following features, wherein deploying, using the CM a new configuration-variant, comprises: setting a context state of the new context to deployment; configuring a deploy tool to use the new context; and upon completion of the deploying, configuring the context state of the new context to restricted use.

A third feature, combinable with any of the previous or following features, wherein assigning, using the CM, a context for use by users connecting to a database schema for the new context, comprises: specifying usage criteria of the new context, wherein the usage criteria comprises: IDs of users that will use the new context to create new data objects when starting new processes; and a percentage of new data objects to be created using the new context.

A fourth feature, combinable with any of the previous or following features, wherein determining, using the CM, to phase out use of the new configuration-variant, comprises: switching, using the CM, a context state of the new context to phase-out, comprising: processing existing data objects within the new context until they are considered closed; and upon a determination that the existing data objects are closed and the context state of the new context is phase-out: setting the context state of the new context to merge; and removing configuration entries for domains assigned to the new context.

A fifth feature, combinable with any of the previous or following features, comprising: migrating, to a default context, data of data objects created while the new context is in the context state of merge.

A sixth feature, combinable with any of the previous or following features, wherein cleaning up the new context, comprises: setting a context state of the new context to clean-up; deleting the new configuration-variant; removing the new context from configuration tables; and deleting the database schema of the new context.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A computer-implemented method, comprising:
creating, using a context manager (CM), a new context;
deploying, using the CM, a new configuration-variant;
assigning, using the CM, the new context for use by users connecting to a database schema of the new context;
determining, using the CM, to phase out use of the new configuration-variant, wherein determining, using the CM, to phase out use of the new configuration-variant, comprises:
switching, using the CM, a context state of the new context to phase-out, comprising:
processing existing data objects within the new context until they are considered closed; and
upon a determination that the existing data objects are closed and the context state of the new context is phase-out:
setting the context state of the new context to merge, wherein no data object is processed any longer with the new context; and
removing configuration entries for domains assigned to the new context from a domain context map persistency of the CM, wherein the domain context map persistency stores which contexts are to be considered within a domain; and
cleaning up, using the CM, the new context.

2. The computer-implemented method of claim 1, wherein, creating, using a CM, a new context, comprises:
setting a context state to prepare;
creating a database schema for the new context;
creating a database view in the database schema; and
configuring a database interface to connect to the database schema for user sessions of users using the new context.

3. The computer-implemented method of claim 1, wherein deploying, using the CM a new configuration-variant, comprises:
setting a context state of the new context to deployment;
configuring a deploy tool to use the new context; and
upon completion of the deploying, configuring the context state of the new context to restricted use.

4. The computer-implemented method of claim 1, wherein assigning, using the CM, a context for use by users connecting to a database schema for the new context, comprises:
specifying usage criteria of the new context, wherein the usage criteria comprises:
IDs of users that will use the new context to create new data objects when starting new processes; and
a percentage of new data objects to be created using the new context.

5. (canceled)

6. The computer-implemented method of claim 1, comprising:
migrating, to a default context, data of data objects created while the new context is in the context state of merge.

7. The computer-implemented method of claim 1, wherein cleaning up the new context, comprises:
setting a context state of the new context to clean-up;
deleting the new configuration-variant;
removing the new context from configuration tables; and
deleting the database schema of the new context.

8. A non-transitory, computer-readable medium storing one or more instructions executable by a computer system to perform one or more operations, comprising:
creating, using a context manager (CM), a new context;
deploying, using the CM, a new configuration-variant;
assigning, using the CM, the new context for use by users connecting to a database schema of the new context;
determining, using the CM, to phase out use of the new configuration-variant, wherein determining, using the CM, to phase out use of the new configuration-variant, comprises:
switching, using the CM, a context state of the new context to phase-out, comprising:
processing existing data objects within the new context until they are considered closed; and
upon a determination that the existing data objects are closed and the context state of the new context is phase-out:
setting the context state of the new context to merge, wherein no data object is processed any longer with the new context; and
removing configuration entries for domains assigned to the new context from a domain context map persistency of the CM, wherein the domain context map persistency stores which contexts are to be considered within a domain; and
cleaning up, using the CM, the new context.

9. The non-transitory, computer-readable medium of claim 8, wherein, creating, using a CM, a new context, comprises:
setting a context state to prepare;
creating a database schema for the new context;
creating a database view in the database schema; and
configuring a database interface to connect to the database schema for user sessions of users using the new context.

10. The non-transitory, computer-readable medium of claim 8, wherein deploying, using the CM a new configuration-variant, comprises:
setting a context state of the new context to deployment;
configuring a deploy tool to use the new context; and
upon completion of the deploying, configuring the context state of the new context to restricted use.

11. The non-transitory, computer-readable medium of claim 8, wherein assigning, using the CM, a context for use by users connecting to a database schema for the new context, comprises:
specifying usage criteria of the new context, wherein the usage criteria comprises:
IDs of users that will use the new context to create new data objects when starting new processes; and
a percentage of new data objects to be created using the new context.

12. (canceled)

13. The non-transitory, computer-readable medium of claim 8, comprising:
migrating, to a default context, data of data objects created while the new context is in the context state of merge.

14. The non-transitory, computer-readable medium of claim 8, wherein cleaning up the new context, comprises:
setting a context state of the new context to clean-up;
deleting the new configuration-variant;
removing the new context from configuration tables; and
deleting the database schema of the new context.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
creating, using a context manager (CM), a new context;
deploying, using the CM, a new configuration-variant;
assigning, using the CM, the new context for use by users connecting to a database schema of the new context;
determining, using the CM, to phase out use of the new configuration-variant, wherein determining, using the CM, to phase out use of the new configuration-variant, comprises:
switching, using the CM, a context state of the new context to phase-out, comprising:
processing existing data objects within the new context until they are considered closed; and
upon a determination that the existing data objects are closed and the context state of the new context is phase-out:
setting the context state of the new context to merge, wherein no data object is processed any longer with the new context; and
removing configuration entries for domains assigned to the new context from a domain context map persistency of the CM, wherein the domain context map persistency stores which contexts are to be considered within a domain; and
cleaning up, using the CM, the new context.

16. The computer-implemented system of claim 15, wherein, creating, using a CM, a new context, comprises:
setting a context state to prepare;
creating a database schema for the new context;
creating a database view in the database schema; and
configuring a database interface to connect to the database schema for user sessions of users using the new context.

17. The computer-implemented system of claim 15, wherein deploying, using the CM a new configuration-variant, comprises:
setting a context state of the new context to deployment;
configuring a deploy tool to use the new context; and
upon completion of the deploying, configuring the context state of the new context to restricted use.

18. The computer-implemented system of claim 15, wherein assigning, using the CM, a context for use by users connecting to a database schema for the new context, comprises:
specifying usage criteria of the new context, wherein the usage criteria comprises:
IDs of users that will use the new context to create new data objects when starting new processes; and
a percentage of new data objects to be created using the new context.

19. (canceled)

20. The computer-implemented system of claim 15, comprising:
migrating, to a default context, data of data objects created while the new context is in the context state of merge.

21. The computer-implemented method of claim 1, wherein small deltas of the new configuration-variant are stored in one or more multi-version tables.

22. The non-transitory, computer-readable medium of claim 8, wherein small deltas of the new configuration-variant are stored in one or more multi-version tables.

23. The computer-implemented system of claim 15, wherein small deltas of the new configuration-variant are stored in one or more multi-version tables.
